(19) United States
(12) Patent Application Publication
(10) Pub. No.: US 2011/0113769 A1
(43) Pub. Date: May 19, 2011

(54) ENERGY STORAGE SYSTEM

(75) Inventor: Jan Olsen, Soenderborg (DK)

(73) Assignee: GODevelopment ApS, Augustenborg (DK)

(21) Appl. No.: 12/999,498

(22) PCT Filed: May 30, 2009
(86) PCT No.: PCT/DK09/00124

§ 371 Date: Jan. 13, 2011

(51) Int. Cl. F15B 1/02; F03B 13/06

(52) U.S. Cl. 60/416; 60/413

(57) ABSTRACT

The invention provides a storage system for storing large amounts of energy. The storage system compensates for fluctuations in power consumption in an electrical power supply grid, and it may be useful e.g. in combination with various sources of renewable energy. The system comprises a reservoir, a load, and an energy conversion structure. The load provides a bias-force on the reservoir and thereby biases the reservoir towards a configuration with a smaller volume. When surplus electrical power is available, a turbine or similar energy conversion structure can work against the load by pumping water into the reservoir. At a later point in time, the conversion structure may regenerate electrical power based on flow energy when the fluid is released from the reservoir under pressure from the bias-force from the load.

### CROSS REFERENCE TO RELATED APPLICATIONS

This application is entitled to the benefit of and incorporates by reference essential subject matter disclosed in International Patent Application No. PCT/DK2009/000124 filed on May 30, 2009 and Danish Patent Application No. PA 2008 00843 filed on Jun. 17, 2008.

### TECHNICAL FIELD

The present invention relates to a storage system for storing energy. In particular, the invention relates to a system capable of storing a large amount of energy at a fixed location. The invention further relates to a method of compensating for fluctuations in a power supply and a method of preventing a low-ground area from being flooded.

### BACKGROUND OF THE INVENTION

The capability of storing large amounts of energy is demanded not least due to the increasing use of renewable energy sources e.g. solar, water or wind power, or due to the use of electrical power plants which operate most efficiently with a constant output or plants which provide a power output which cannot be adjusted very fast. In such power systems—or power grids, the fluctuation in demand for electrical power causes a strong need for storing surplus energy for later use.

Batteries and other chemical-based energy storage systems typically suffer from being expensive and space consuming relative to the energy which can be stored. Additionally, toxic or environmentally hazardous elements such as acid, heavy metals or hydrogen etc often limit the applicability of such systems in large scale systems. Also the limited availability of specific materials, such as lead or other metals for batteries, may prevent the building of large scale systems.

In a so called “pumped energy storage”, US 2005/0034452 is an example of this type, water is typically pumped between two reservoirs located at different altitudes. The lower reservoir is typically a lake or the sea. This solution, however, requires a specific configuration of the ground, preferably near a lake or at the coast, and the necessary difference in altitude may not always be available. In addition, leakage of water, not least salt water or otherwise polluted water from an elevated location may cause severe damage to the ground water. Furthermore, known pumped energy storages are typically designed for the maximum possible storage capacity, because the cost of subsequent extensions of the capacity is relatively high. One reason for this is that e.g. basins and pipes cannot be changed without taking the storage system out of operation for a long period of time. Therefore, turbines, pumps, pipes, motors and generators are typically dimensioned to the specific storage location, which typically requires expensive custom design of each storage plant. Known pumped energy storage systems are therefore too expensive to implement as power backup for very large scale power systems.

In general, known systems have a limited scalability and have till now only been used for storage of very small energy amounts, especially when compared to the storage capacity needed to compensate for fluctuations in e.g. a nation-wide electrical power grid. Building a system based on known technologies in a scale large enough for such a purpose, would typically require more space or amounts of materials than is available—at least within an economically reasonable frame.

### DESCRIPTION OF THE INVENTION

It is an object of the invention to provide a system which can store large amounts of energy without use of environmentally undesired chemicals.

It is a further object of the invention to provide an energy storage system which poses only a small risk of polluting the ground water.

It is a further object of the invention to provide an energy storage system which may be placed close to the sea in flat coastal areas.

It is a further object of the invention to provide a modular, economically attractive and easily scalable energy storage system which can be built from standardized equipment and at the same time be built in a scale large enough to enable compensation of fluctuations in a large electrical power grid.

According to a first aspect, the invention provides an energy storage system comprising a reservoir, a load, and an energy conversion structure.

The load and the reservoir are provided so that a volume of the reservoir can be increased by displacement of the load away from a starting point and so that the load, under influence of gravity, can return towards the starting point upon decrease of the volume.

The energy conversion structure is adapted to increase the volume under consumption of energy by pumping a fluid medium into the space, and to decrease the space by releasing the fluid medium from the space while converting flow energy in the fluid medium to mechanical energy.

The mechanical energy may constitute only a preliminary conversion step since the mechanical energy would typically be converted again into electrical energy.

When surplus electrical power is available in an electrical power grid, the surplus power may be consumed while the load is displaced against gravity away from a starting point. When power is needed at a later point in time, the process may be reversed and the potential energy of the raised load may be regenerated as electrical power. Accordingly, a storage system capable of storing large amounts of energy is provided, and since the energy is stored by use of gravity, no hazardous or potentially polluting or costly chemicals need to be involved in the process. Since the flow energy is provided by conversion of the potential energy stored in the load when the load is raised form the starting point, the system may be implemented also at flat locations without any natural altitude differences in the landscape.

The load may be naturally existing material such as soil, sand, clay, gravel, pebbles etc. preferably comprises materials naturally existing in the ground where the system is made.

The reservoir may e.g. be constituted by a flexible membrane which is arranged below ground. In this case, the ground may constitute the load. Typically, the reservoir would be made for storage of regular water, e.g. salt water or fresh water from a lake or from the sea. In this case, the reservoir may also constitute or form part of a fresh water supply, an emergency reservoir for fire fighting purpose, or it may be used for preventing low grounds from being flooded, e.g. in case of emergency.

In one embodiment, the reservoir comprises a membrane forming an enclosed space, and the load acts upon an upper layer of the membrane. The upper membrane layer may be joined to a lower layer so that a space is formed between the layers, the layers may be joined in a joint-zone at an edge portion of the layers, and the joint-zone being located below the remaining part of the reservoir.

In one embodiment, the upper and lower membrane layers are made of different materials.

In a further embodiment, the upper membrane layer is made of a material having a density lower than the fluid medium and the lower membrane is made of a material having a larger density than the fluid medium. By selecting different materials, it will be possible to avoid descending or ascending of the membrane layer in a situation, where the surrounding earth is saturated with water.

The membrane could be made from a polymer material and it could generally be of the kind known for swimming pools etc. A suitable material could be high density polyethylene (HDPE). The reservoir could have a solid bottom e.g. made of concrete, or the membrane may comprise an upper and a lower flexible layer joined along the edges thereof. The membrane could be made e.g. of metal or bentonite, or by saturating a sand layer with tar or another material with similar properties.

An edge of the membrane may be buried to a depth below the remaining part of the reservoir. This will compensate for the fluid pressure inside the reservoir and support the joint between the upper and lower flexible layers of the membrane. The edge could typically have a depth of up to two meters or more below the bottom of the remaining part of the reservoir.

To protect the membrane against damage, a layer of sand may be arranged below the reservoir.

The load preferably comprises materials naturally existing in the ground where the system is made, like soil, sand, clay, gravel, pebbles etc.

Typically, the reservoir could have a size in the range of between 400×400×8 and 500×500×12 meters, i.e. a surface size of 160,000-250,000 square meters and a height of 8-12 meters. The load could be constituted by a 20-25 meters thick layer of soil, pebbles, gravel, sand, clay or similar naturally existing material in the ground where the system is made. In this way, the existing ground could be removed in an area of the above mentioned 160,000-250,000 square meters in a layer thickness of 20-25 meters and a membrane which forms an enclosed space could be arranged where the ground-material is removed. Subsequently the enclosed space is connected by a conduit system to the energy conversion structure, and the removed ground-material is re-arranged on top of the membrane. With a soil density of 2,500 kg pr cubic meter, the storage may obtain a capacity of approximately 200 MWh and a water pressure when the reservoir is filled with water, of approximately 5 bar. The system may preferably be dimensioned for an operating water pressure in the range between 2 bar and 10 bar, which allows for both the use of efficient turbines and the use of standard piping materials.

Herein, the starting point is defined as the position of the membrane when the reservoir is empty. The starting point could e.g. be a position where the upper layer and the lower layer contact each other.

By flow energy of the fluid is herein meant e.g. the kinetic or potential energy which is derivable from the fluid when it flows out of the reservoir.

In one embodiment the conversion structure comprises a turbine which is operable by mechanical energy by displacing fluid into the reservoir and operable by flow energy of the fluid to provide mechanical energy.

Furthermore the conversion structure may comprise a generator operable with the mechanical energy to provide electrical energy.

The energy conversion structure may be e.g. a standard pumping turbine such as a Francis turbine, a double-controlled diagonal turbine such as a Deriaz turbine, or a vertical Kaplan turbine. The conversion structure may also comprise a pump and a turbine as separate components where the pump is used for filling the fluid into the reservoir and the turbine is used for converting the flow energy from the fluid into mechanical energy. The conversion structure may further comprise a combined drive and generator means which can drive the turbine based on electricity and which can provide electricity, when driven by the turbine. The conversion structure may also comprise a motor and a generator as two separate components.

As mentioned already, the fluid medium in question would typically be water or similar liquids which are essentially incompressible at the aforementioned 2-10 bar pressure. The use of an incompressible fluid with a density substantially larger than that of air improves both the efficiency and the safety of the system. It also ensures that the reservoir ceiling will move up- and downwards in a controlled and stable way.

To determine the energy content in the system, a height measuring structure may be arranged to determine a height of the reservoir. In one example, the height measuring structure simply determines the distance by which the ground above the reservoir has been raised above a zero-level with no energy in the system. In another example, the distance between the upper and lower layers in the reservoir is measured, e.g. by use of optic or acoustic, i.e. a sonar-based measuring devices. Several devices may be used to determine a more detailed height profile of the reservoir ceiling. The energy content may also be determined by measuring a flow of the fluid medium when it is pumped into or displaced out of the reservoir.

To enable detection of leakage of the fluid medium from the reservoir, the system may comprise a leak detection structure that may be a structure comprising a sensor adapted to acoustic sensing. A sensor for acoustic sensing can detect fluid flow, e.g. within the reservoir or through holes in the reservoir wall, or which can detect movement of the load. Alternatively, or additionally, the system may comprise a fluid sensor, e.g. arranged in communication with the reservoir via a drainage conduit which is provided below and/or above the reservoir to drain possibly leaked fluid to the fluid sensor. Herein, a fluid sensor means a sensor adapted to detect the occurrence of a fluid and/or adapted to measure a property of a fluid, such as e.g. salinity.

Advantageously, the system comprises a plurality of reservoirs, each arranged below a load which thereby acts upon the reservoir, so that the volume of the reservoirs can be increased by displacement of the load away from the starting point, and so that the load can return towards the starting point upon a decrease of the volume, wherein the energy conversion structure is connected to each reservoir via a connection structure comprising a valve for each reservoir.

To increase flexibility and performance, the system may comprise a plurality of the mentioned reservoirs. In this case, the energy conversion structure may be connected to each reservoir via a connection structure which comprises a valve for each reservoir so that they can be activated or deactivated individually. The system may further comprise several energy conversion structures, each connected to its own set of reservoirs. Thus, the system may easily be scaled, since it may include an amount of standard components to match a requirement of a specific situation. If the need for storage capacity increases, additional reservoirs and energy conversion structures may be added without having to deactivate the existing elements of the system.

The system may comprise a plurality of reservoirs, e.g. completely separate reservoirs and/or reservoirs with different loads, e.g. reservoirs wherein the amount of soil or sand on top of each reservoir is individually adapted. The use of different loads on different reservoirs facilitates an efficient use of the system, it facilitates a more flexible adaptation of specific storage needs, and it facilitates use of equally dimensioned energy conversion structures even when the reservoirs are placed at different altitudes with respect to the energy conversion structures, e.g. in a sloping landscape. On locations far from natural water sources the system may pump water between reservoirs located at different altitudes and/or with different loads. As an example, a solar power plant could be electrically connected to a system comprising two reservoirs, whereof one reservoir could be placed deep below the surface of the soil or sand and the other reservoir shallow, such that there would be a pressure difference between the water pressures in the two reservoirs. Using an enclosed low-pressure reservoir would prevent water from evaporating, like it would from an open reservoir. In this way, a constant-power solar power plant could be realized e.g. in a desert area.

For maintenance and inspection purpose, the reservoir may comprise a lock which allows entrance of service personnel and/or a robot.

In a second aspect, the invention provides a method of compensating for fluctuations in demand or production in an electrical power supply system. According to this method a system of the kind described above is provided. The volume of at least one reservoir is increased under consumption of surplus electrical power from a power supply by pumping a fluid medium into the reservoir. At a later point in time, when electrical power is demanded, the space is decreased again by releasing the fluid medium from the space while converting flow energy in the fluid medium to electrical energy.

In a third aspect, the invention provides a method to prevent a low-ground area from being flooded. According to this method a system of the kind described above is provided below ground between the low-ground area and a body of water, and the reservoir is used as a dynamic dike. The term “body of water” refers to large accumulations of water, such as oceans, seas and lakes, but it may also include smaller pools of water such as ponds, puddles or wetlands, rivers, streams, canals, and other geographical features where water may cause damage to adjacent low-ground areas, or where a controlled flooding of low-ground areas is desirable, e.g. for irrigation.

The volume of at least one reservoir is increased or decreased depending on a water level of an adjacent lake, sea or river, and/or depending on the need to store surplus energy or to release stored energy. In this way, the ground can be raised to prevent a low-ground area from being flooded. Likewise, the ground can be lowered in order to flood a low-ground area depending on the need for irrigation of the area, which may be e.g. an agricultural area.

### BRIEF DESCRIPTION OF THE DRAWINGS

In the following, preferred embodiments of the invention will be described in further details with reference to the drawings in which:

FIG. 1 illustrates a cross-section of an energy storage system according to the invention;

FIG. 2 illustrates the reservoir of the system in FIG. 1 in further details;

FIG. 3 illustrates the system from FIG. 1 in a perspective view;

FIGS. 4-8 illustrate various embodiments of the system with several reservoirs; and

FIG. 9 illustrates the reservoir of the system in FIG. 1 with drainage conduits.

### DETAILED DESCRIPTION OF THE PREFERRED EMBODIMENTS

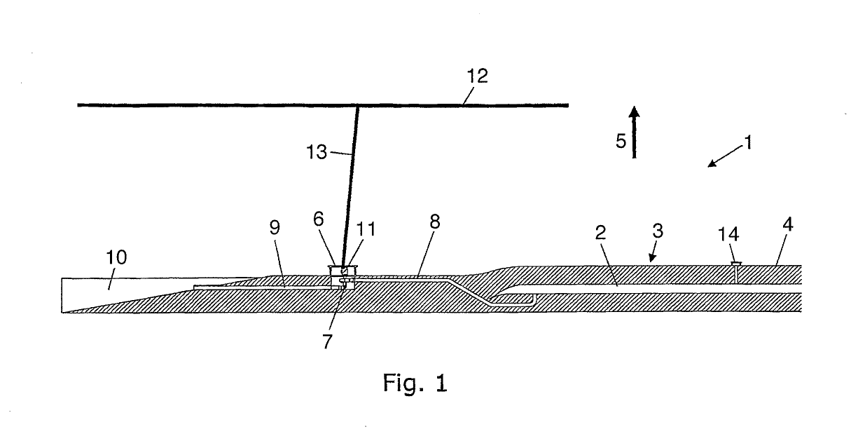

FIG. 1 illustrates in a cross-section, an energy storage system 1 comprising a reservoir 2 forming a space below ground level 3. A load 4, constituted by a layer of sand or soil, acts on the reservoir 2 so that the volume of the space can be increased by displacement of the soil in an upward direction, indicated by the arrow 5, away from a starting point and so that the soil, under influence of gravity, can return towards the starting point when the volume decreases. Accordingly, the weight of the soil provides a bias-force on the reservoir 2 towards a smaller volume.

The energy storage system 1 further comprises an energy conversion structure 6 which can pump water into the space and thereby increase the volume by displacing the load 4 against its weight. The energy conversion structure 6 can also operate in a reversed mode where the water is displaced out of the reservoir 2 by the bias-force provided by the load 4. In this mode, the flow energy is converted by the conversion structure 6 to mechanical energy. In the disclosed embodiment, the conversion structure 6 comprises a turbine located in a turbine chamber 7 below ground. The turbine chamber 7 is connected by an upstream conduit 8 to the reservoir 2, and by a downstream conduit 9 to a water supply 10, in this case a lake.

Above ground, the energy conversion structure 6 comprises a combined electrical motor and electrical generator 11. When surplus electrical power is available, the conversion structure 6 receives electrical power from the power supply 12 via the connection 13. The power is consumed by the electrical motor 11 and water is pumped from the water supply 10 into the reservoir 2. When electrical power is needed, water is released from the reservoir 2 and the flow energy makes the turbine rotate. The turbine thereby drives the electrical generator 11 which delivers electrical power to the power supply 12.

The energy storage system 1 comprises a lock 14 with a hatch cover which provides a sealable way to access the reservoir 2 for inspection and maintenance, e.g. by a diver or a robot.

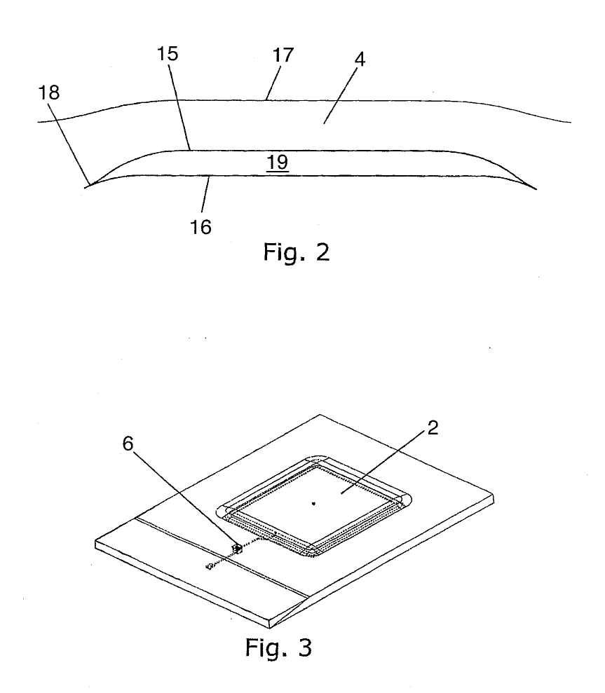

The reservoir 2 is illustrated in further details in FIG. 2. The reservoir 2 comprises a membrane forming an upper layer 15 towards the load 4 and a lower layer 16 towards the ground below the reservoir 2. The upper layer 15 may be made of a material having a density lower than the fluid in the reservoir and the lower membrane layer may be made of a material having a larger density than the fluid in the reservoir. Both layers are located approximately 10-30 meters below the ground surface 17, and they are joined peripherally along the edge 18 so that they form a sealed space 19. To strengthen the assembly between the layers 15, 16 and to compensate for the fluid pressure inside the reservoir 2, the edge 18 is buried to a lower depth than the remaining part of the reservoir 2. The height of the soil or sand on top of the reservoir may be individually adapted to the density of the soil/sand at each specific location. This allows for the use of standardized turbines, generators etc., which are optimized for a specific flow and pressure, thereby making the implementation less expensive and at the same time increasing the energy efficiency of the system.

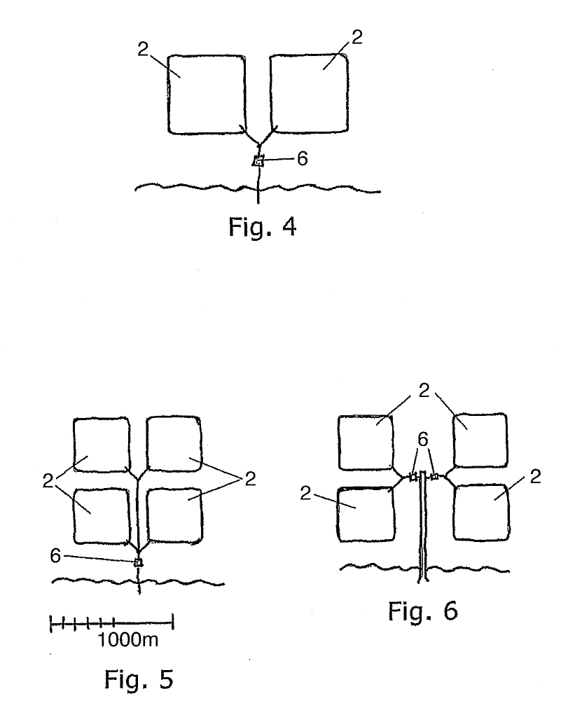

FIG. 3 illustrates the system from FIG. 1 in a perspective view.

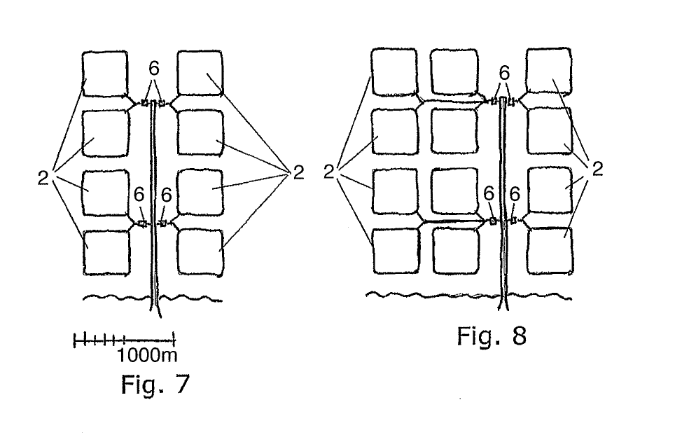

FIGS. 4-8 illustrate various embodiments of the system with 2, 3, 4 and more reservoirs connected to the same conversion structure via a connection structure including a valve for each reservoir so that the reservoirs may be used independently in response to the actual need for storage or consumption of energy. The illustrated systems may provide e.g. a yield between 30 MW and 120 MW and a storage capacity between 200 MWh and 2400 MWh depending on size and number of the reservoirs. Several systems of equal dimensions may be connected together, thereby making it easy to dimension a total system for a specific storage capacity.

In FIGS. 6-8, the energy conversion structures are connected to e.g. the sea through a common channel in order to save the cost for laying large pipes.

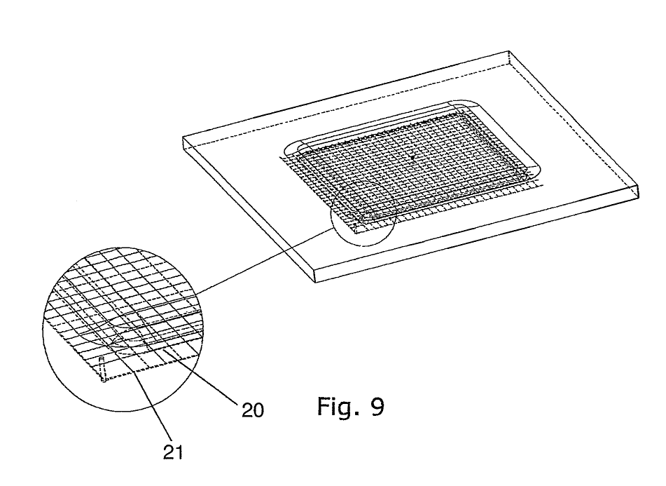

As illustrated in FIG. 9 a grid of drainage conduits 20 may be arranged below the reservoir 2 to drain possibly leaked fluid to a fluid sensor for detecting leakage of fluid from the reservoir 2. As illustrated, the grid forms a plurality of joints between conduits, and each conduit 20 is formed with openings so that possibly leaked fluid can drain into the grid of conduits 20. Further drainage conduits may be arranged above the reservoir 2 to allow detection of leaks in the upper membrane 15. The drainage conduits 20 may be arranged in a matrix-like arrangement, so that a leakage at a specific location will cause leaked fluid to appear at the outlets 21—or at fluid sensors in the conduits—of a specific pair of conduits, thereby allowing the determination of the leakage location. A leak of salt water may e.g. be detected by measuring or monitoring the conductivity of the water in the drainage conduits 20.

While the present invention has been illustrated and described with respect to a particular embodiment thereof, it should be appreciated by those of ordinary skill in the art that various modifications to this invention may be made without departing from the spirit and scope of the present.

What is claimed is:

1.-18. (canceled)

19. An energy storage system comprising a reservoir, a load, and an energy conversion structure, the load acting on the reservoir so that a volume of the reservoir can be increased by displacement of the load away from a starting point and so that the load can return towards the starting point upon decrease of the volume, the energy conversion structure being adapted to increase the volume under consumption of energy by pumping a fluid medium into the space, and to decrease the space by releasing the fluid medium from the space while converting flow energy in the fluid medium to mechanical energy wherein the reservoir comprises a membrane forming an enclosed space, and the load acts on an upper layer of the membrane, and the load comprises naturally existing material such as soil, sand, clay, gravel, pebbles etc.

20. The system according to claim 19, wherein the upper layer is joined to a lower layer so that a space is formed between the layers, the layers being joined in a joint-zone at an edge portion of the layers, and the joint-zone being located below the remaining part of the reservoir.

21. The system according to claim 19, wherein the upper membrane layer is made of a material having a density lower than the fluid medium and the lower membrane layer is made of a material having a larger density than the fluid medium.

22. The system according to claim 19, wherein the conversion structure comprises a turbine which is operable by mechanical energy to displace fluid into the reservoir and operable by flow energy of the fluid to provide mechanical energy.

23. The system according to claim 22, wherein the conversion structure comprises a generator operable with the mechanical energy to provide electrical energy.

24. The system according to claim 19, wherein the reservoir is arranged below ground.

25. The system according to claim 24, comprising at least one height measuring structure arranged to determine a height of the reservoir.

26. The system according to claim 24, comprising a layer of sand arranged below the reservoir.

27. The system according to claim 19, comprising a leak detection structure for detecting leakage of the fluid medium from the reservoir.

28. The system according to claim 27, wherein the leak detection structure comprises a sensor adapted to acoustic sensing.

29. The system according to claim 27, wherein the leak detection structure comprises a fluid sensor and a drainage conduit arranged below and/or above the reservoir to drain possibly leaked fluid to the fluid sensor.

30. The system according to claim 19, comprising a plurality of reservoirs each arranged below a load which thereby acts on the reservoirs so that a volume of the reservoirs can be increased by displacement of the load away from a starting point and so that the load can return towards the starting point upon decrease of the volume, wherein the energy conversion structure is connected to each reservoir via a connection structure which comprises a valve for each reservoir.

31. The system according to claim 30, comprising individual loads for each reservoir.

32. The system according to claim 19, comprising a lock allowing entrance into the reservoirs for inspection and maintenance.

33. The system according to claim 19, wherein the fluid medium is fresh water.

34. The system according to claim 19 for storage of fresh water.

35. A method of compensating for fluctuations in demand or production in an electrical power supply system, the method comprising:
providing a system according to claim 19;
increasing the volume of at least one reservoir under consumption of surplus electrical power from a power supply by pumping a fluid medium into the reservoir; and
decreasing the space by releasing the fluid medium from the space while converting flow energy in the fluid medium to electrical energy.

36. A method of preventing a low-ground area from being flooded, the method comprising:
providing a system according to claim 19, the reservoir of the system being provided below ground between the low-ground area and a body of water; and
increasing or decreasing the volume of at least one reservoir depending on a water level of the body of water or depending on the need to store or release surplus energy from the system.
